(19) United States
(12) Patent Application Publication
(10) Pub. No.: US 2015/0145970 A1
(43) Pub. Date: May 28, 2015

(54) METHOD AND APPARATUS FOR IMAGE PROCESSING

(71) Applicant: Samsung Electronics Co., Ltd., Suwon-Si (KR)

(72) Inventors: Yoo Kyung KIM, Suwon-si (KR); Dong-kyung NAM, Yongin-si (KR); Ju Yong PARK, Seongnam-si (KR); Jin Ho LEE, Suwon-si (KR); Seo Young CHOI, Seoul (KR)

(21) Appl. No.: 14/456,116

(22) Filed: Aug. 11, 2014

(30) Foreign Application Priority Data
Nov. 22, 2013 (KR) 10-2013-0143117

(51) Int. Cl. H04N 13/04; G06T 15/50

(52) U.S. Cl. CPC H04N 13/0422; H04N 13/0402; G06T 15/50
USPC 348/54

(57) ABSTRACT

An apparatus for image processing controls a luminance of at least one light beam projected to a surface of a screen by at least one light source by controlling the at least one light source that emits the at least one light beam, wherein a luminance of an image output to the screen may be uniform by the luminance of the at least one light beam projected to the surface of the screen being controlled.

### CROSS-REFERENCE TO RELATED APPLICATION

This application claims the priority benefit of Korean Patent Application No. 10-2013-0143117, filed on Nov. 22, 2013, in the Korean Intellectual Property Office, the entire disclosure of which is incorporated herein by reference.

### BACKGROUND

1. Field

Example embodiments of the following description relate to image processing, such as an apparatus and method for image processing that controls luminance and/or color information of at least one light source.

2. Description of the Related Art

In recent times, efforts to develop a three-dimensional (3D) display device for viewing a more realistic image have been accelerated. The 3D display device may provide a 3D stereoscopic image to a viewer. The 3D display device may be classified into a glasses-type stereoscopic 3D display device and an auto-stereoscopic 3D display device.

The auto-stereoscopic 3D display device may have more advantages than the glasses-type stereoscopic 3D display device in that a viewer is enabled to recognize a 3D image without wearing additional glasses.

The auto-stereoscopic 3D display device may be implemented based on a multi-view display technology based on a lenticular lens and/or a light field (LF) display technology based on ray tracing.

### SUMMARY

A method of image processing includes determining a luminance compensation coefficient of at least one light beam from at least one light source based on a spatial angular distribution of the at least one light beam projected, generating information about at least one image based on the determined luminance compensation coefficient, and outputting the information about the at least one image to the at least one light source.

The determining of the luminance compensation coefficient may include determining a luminance distribution of the at least one light beam based on the spatial angular distribution, determining a target luminance distribution based on the determined luminance distribution, and calculating the determined luminance compensation coefficient of the at least one light beam based on the determined luminance distribution and the determined target luminance distribution.

The at least one light beam projected from at least one light source may pass through a pixel in the image.

The calculating of the luminance compensation coefficient may include determining the luminance compensation coefficient based on a similarity between the determined luminance distribution and the determined target luminance distribution.

The determining the luminance distribution may determine the determined luminance distribution based on empirical data.

The determining of the luminance distribution may include synthesizing the calculated luminance distribution.

The method may further include adjusting a luminance of the at least one light source.

The adjusting of the post-processing may increase or decrease the luminance of the at least one light source by a predetermined and/or desired rate.

The luminance compensation coefficient may be determined for a plurality of light beams projected from the at least one light source that passes through a pixel in the image.

The luminance compensation coefficient may be determined for a plurality of pixels in the image through which the at least one light beam passes.

The method may further include determining a color compensation coefficient of the at least one light beam based on the spatial angular distribution of the at least one light beam, and generating information about the at least one image based on the determined color compensation coefficient.

The determining of the color compensation coefficient may include determining a color distribution of the at least one light beam based on the spatial angular distribution, determining a target color distribution based on the determined color distribution, and calculating the determined color compensation coefficient of the at least one light beam based on the determined color distribution and the determined target color distribution.

The color distribution may correspond to a distribution of at least one of red (R), green (G), blue (B), and gamma of the at least one light beam.

The determining the target color distribution may determine the target color distribution based on content, and the at least one image corresponds to an image displaying the content.

An apparatus for image processing includes a luminance compensation coefficient determiner configured to determine a luminance compensation coefficient of at least one light beam from at least one light source based on a spatial angular distribution of the at least one light beam, an image information generator configured to generate information about at least one image based on the determined luminance compensation coefficient, and an image information outputter configured to output the information about the at least one image to the at least one light source.

The luminance compensation coefficient determiner may determine a luminance distribution of the at least one light beam based on the spatial angular distribution, determine a target luminance distribution based on the determined luminance distribution, and calculate the determined luminance compensation coefficient of the at least one light beam based on the determined luminance distribution and the determined target luminance distribution.

The apparatus may further include a color compensation coefficient determiner configured to determine a color compensation coefficient of the at least one light beam based on the spatial angular distribution of the at least one light beam. The image information generator may generate information about at least one image based on the determined color compensation coefficient.

The color compensation coefficient determiner may determine a color distribution of the at least one light beam based on the spatial angular distribution, determine a target color distribution based on the determined color distribution, and calculate the determined color compensation coefficient of the at least one light beam based on the determined color distribution and the determined target color distribution.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIG. 1 illustrates a relationship between at least one light beam projected to a screen by at least one light source and a viewer according to a related art;

FIG. 2 illustrates at least one light beam that passes through a pixel according to a related art;

FIG. 3 illustrates at least one light beam that passes through a screen at differing spatial angles according to a related art;

FIG. 4 illustrates a spatial angular distribution of at least one light beam according to a related art;

FIG. 5 illustrates an apparatus for image processing according to an example embodiment;

FIG. 6 illustrates a method of image processing according to an example embodiment;

FIG. 7 illustrates a method of determining a luminance compensation coefficient according to an example embodiment;

FIG. 8 illustrates a method of calculating a luminance distribution of at least one light beam according to an example embodiment;

FIG. 9 illustrates a method of image processing according to an example embodiment;

FIG. 10 illustrates a method of determining a color compensation coefficient according to an example embodiment;

FIG. 11 illustrates at least one light beam that passes through a pixel according to an example embodiment;

FIG. 12 illustrates a method of calculating a luminance distribution of at least one light beam according to an example embodiment;

FIG. 13 illustrates a method of determining a target luminance distribution according to an example embodiment;

FIG. 14 illustrates a method of compensating for a luminance using a luminance compensation coefficient according to an example embodiment;

FIG. 15 illustrates a luminance distribution and a target luminance distribution according to an example;

FIG. 16 illustrates a luminance distribution compensated for by a luminance compensation coefficient and a target luminance distribution according to an example;

FIG. 17 illustrates a luminance compensation coefficient according to an example;

FIG. 18 illustrates a grey image prior to a luminance compensation and a grey image subsequent to a luminance compensation according to an example;

FIG. 19 illustrates a white image prior to a luminance compensation and a white image subsequent to a luminance compensation according to an example; and

FIG. 20 illustrates a content image prior to a luminance compensation and a content image subsequent to the luminance compensation according to an example.

### DETAILED DESCRIPTION

Example embodiments will now be described more fully with reference to the accompanying drawings. Many alternate forms may be embodied and example embodiments should not be construed as limited to example embodiments set forth herein. In the drawings, like reference numerals refer to like elements.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware in existing electronic systems (e.g., a 3D display device). Such existing hardware may include one or more Central Processing Units (CPUs), digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors may be programmed to perform the necessary tasks, thereby being transformed into special purpose processor(s) or computer(s).

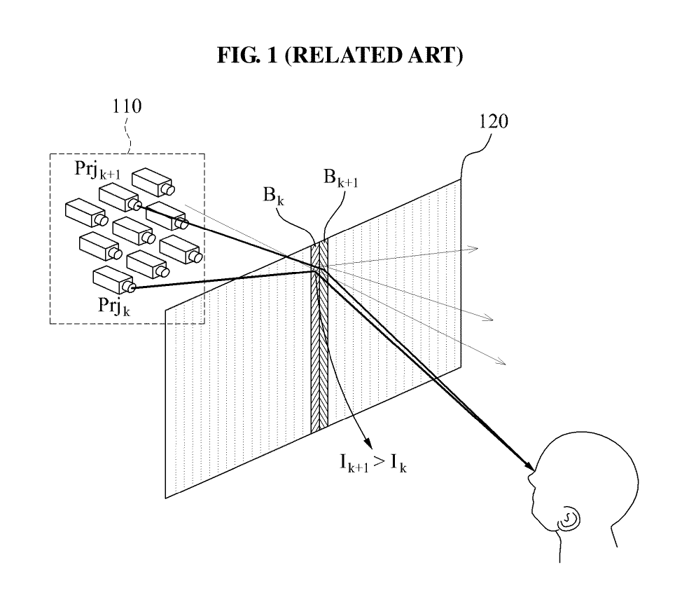

FIG. 1 illustrates a relationship between at least one light beam projected to a screen 120 by at least one light source 110 and a viewer according to a related art.

A method in which at least one light beam is projected to a surface of the screen 120 by the at least one light source 110 and the viewer recognizes an image output to the screen 120 is illustrated in FIG. 1.

The at least one light source 110 emits at least one light beam. The emitted at least one light beam is projected to the surface of the screen 120.

Although not illustrated, the at least one light source 110 represents a portion of all light sources that project at least one light beam to the surface of the screen 120.

Descriptions are omitted in FIG. 1 for ease of conciseness, however, each of the at least one light source 110 emits at least one light beam, and the emitted at least one light beam is projected to differing areas on a screen. Alternatively, a light source projects a light beam to differing areas on a screen sequentially or iteratively. In this example, the light source changes a position at which the light beam is projected in a predetermined and/or desired area on the screen.

An anisotropic diffusion film is attached to a front of the screen 120. Alternatively, a sheet or a film including lenticular lenses is attached to the front of the screen 120. At least one light beam is projected, by the at least one light source 110, to the film or the sheet attached to the front of the screen 120.

The at least one light source 110 and the screen 120 include a portion of a display device. For example, a multi-view three-dimensional (3D) display device or a flat display device includes the at least one light source 110 and the screen 120.

At least one light beam is projected to the surface of the screen 120 at differing spatial angles. The viewer recognizes an input image output to the screen 120 in response to the at least one light beam being projected to the surface of the screen 120 at the differing spatial angles. As used herein, the spatial angle, a value greater than −90 degrees and less than 90 degrees, may refer to a radiation angle at which a light beam is projected.

When the at least one light beam is projected to the surface of the screen 120 at the differing spatial angles, luminance and/or color information of the projected light beam differs from one another based on the differing spatial angles at which the at least one beam is projected. The viewer differently recognizes an image output based on a luminance of the projected light beam. For example, the viewer recognizes an image output to an area on the screen 120 to which light beams having a less luminance are projected to be a darker image than an image output to an area on the screen 120 to which light beams having a greater luminance are projected.

For example, a luminance Iₖ of a light beam projected to an area Bₖ on the screen 120 by a light source Prjₖ may be less than a luminance Iₖ₊₁ of a light beam projected to an area Bₖ₊₁ on the screen 120 by a light source Prjₖ₊₁ amongst the at least one light source 110. The viewer recognizes an image displayed in the area Bₖ on the screen 120 to be a darker image than an image displayed on the area Bₖ₊₁ on the screen 120. A luminance distribution of an overall image output to the screen 120 may not be uniform because the luminances of the images output to the areas Bₖ and Bₖ₊₁ adjacent to each other of the screen 120 differ from each other.

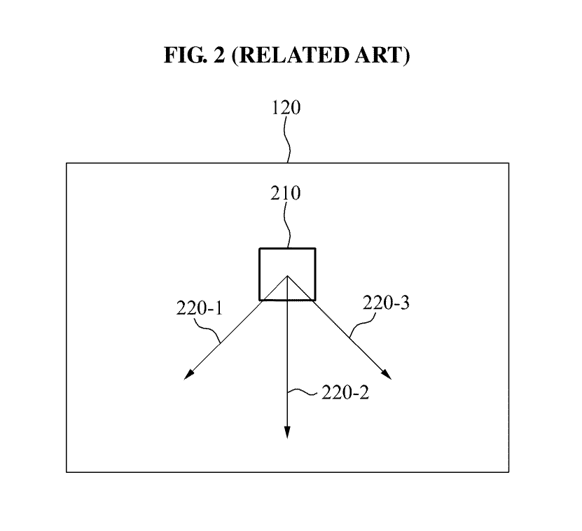

A method of projecting the at least one light beam to the surface of the screen 120 will be described with reference to FIGS. 2 through 4.

FIG. 2 illustrates at least one light beam that passes through a pixel according to a related art.

Referring to FIG. 2, at least one light beam emitted from the at least one light source 110 converges on a single pixel 210 in an image output to the screen 120. The at least one light beam converging on the pixel 210 is projected to the surface of the screen 120 at differing spatial angles from one another, and is emitted through the screen 120. Images are output to the screen 120 in response to the at least one light beam being emitted through the screen 120.

Three light beams 220-1 through 220-3 that pass through the screen 120 at differing spatial angles through the pixel 210 are illustrated in FIG. 2, however, a number of light beams that pass through the screen 120 at differing spatial angles through the pixel 210 may differ from the example illustrated.

The at least one light source 110, for example, a portion of a total of light sources that project at least one light beam to the surface of the screen 120, refers to a light source that projects at least one light beam to the surface of the screen 120 through the pixel 210.

Luminance and/or color information of the light beams 220-1 through 220-3 projected to the surface of the screen 120 may differ from one another. The luminance and/or color information of the light beams 220-1 through 220-3 differs from one another based on a spatial angle at which each of the light beams 220-1 through 220-3 is projected to the surface.

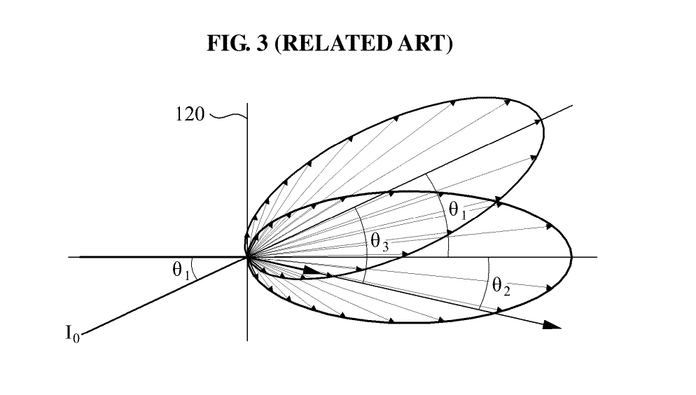

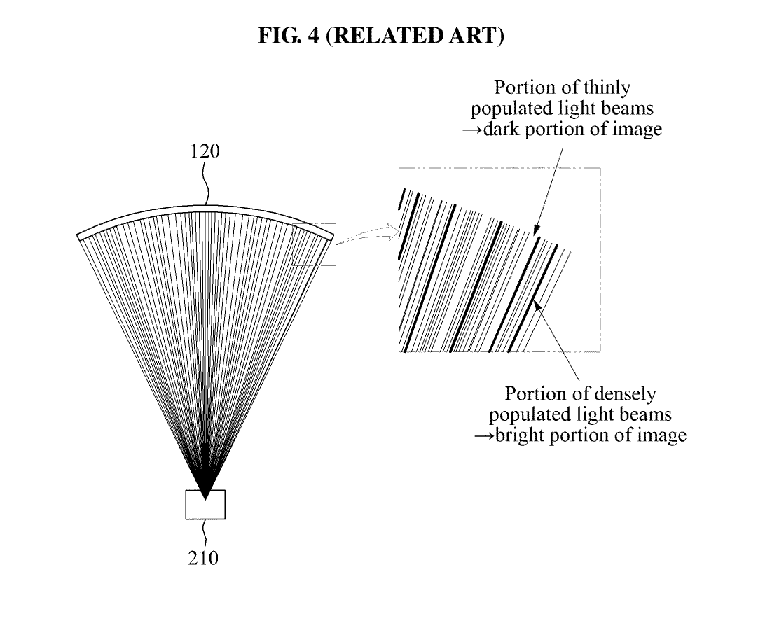

A method of projecting at least one light beam to the surface of the screen 120 will be described with reference to FIGS. 3 and 4.

Since the technical features described with reference to FIG. 1 may be directly applicable here, a detailed description will be omitted for conciseness.

FIG. 3 illustrates at least one light beam that passes through a screen 120 at differing spatial angles according to a related art.

As previously described with reference to FIGS. 1 and 2, a light beam projected by a light source passes through the screen 120 at differing spatial angles. Here, a luminance of the light beam changes in response to the light beam passing through the screen 120 at the differing spatial angles.

For example, in response to a first light beam being input to the screen 120 from a light source, when an incident angle of the first light beam is θ₁ and a luminance of the first light beam is I₀, a luminance I of a second light beam that passes through the screen 120 at a spatial angle of θ₃ with respect to the first light beam input is represented by Equation 1.

$$\begin{matrix}I = {I}_{0} cos ( {θ}_{1} ) f ( {θ}_{3} ) \\ = {I}_{0} cos ( {θ}_{1} ) f ( {θ}_{1} + {θ}_{2} )\end{matrix} \qquad [ Equation 1 ]$$

In Equation 1, a function f(θ) denotes a function that represents a luminance distribution of a light beam with respect to a spatial angle θ. Alternatively, the function f(θ) denotes a function that represents a luminance distribution of a light source with respect to the spatial angle θ, or a function that represents a luminance profile. A value of f(θ) is greater than zero and less than “1”. For example, a luminance of a light beam that passes through the screen 120 at the spatial angle θ is less than a luminance of a light beam emitted from a light source.

The luminance of the light beam that passes through the screen 120 may change based on the spatial angle θ at which the light beam is projected. A luminance distribution of an overall image output to the screen 120 may not be uniform due to the change in the luminance.

The luminance of the light beam represents various distributions. For example, a luminance distribution of the light beam may represent a Gaussian distribution. The luminance distribution of the light beam that represents the Gaussian distribution is expressed by Equation 2.

$${G}_{i} ( θ ) = {w}_{i} exp ( - \frac{{( θ - {c}_{i} )}^{2}}{2 σ} ) \qquad [ Equation 2 ]$$

In Equation 2, wᵢ denotes a luminance of a light beam emitted from a light source i.

cᵢ denotes a spatial angle at which the light beam emitted from the light source i passes through the screen 120. σ denotes a value associated with a horizontal scattering angle characteristic. σ is given by Equation 3.

σ=FWHM/2\sqrt{2log2} [Equation 3]

In Equation 3, FWHM refers to a full width at half maximum (FWHM) of a horizontal scattering angle characteristic distribution.

Since the technical features described with reference to FIGS. 1 and 2 may be directly applicable here, a detailed description will be omitted for conciseness.

FIG. 4 illustrates a spatial angular distribution of at least one light beam according to a related art.

Referring to FIG. 4, a spatial distribution of at least one light beam refers to a distribution of the at least one light beam with respect to a spatial angle.

At least one light beam that passes through the screen 120 at differing spatial angles through the pixel 210 is illustrated in FIG. 4. Although not illustrated, the screen 120 may be a flat screen.

As previously described with reference to FIG. 2, at least one light beam emitted from the at least one light source 110 converges on the pixel 210, and the converging light beam passes through the screen 120 at differing spatial angles through the pixel 210.

As illustrated in FIG. 4, an area in which projected light beams are relatively densely populated and an area in which projected light beams are relatively thinly populated exist among the areas on the screen 120 to which the at least one light beam is projected in response to the at least one light beam being projected to the surface of the screen 120 through the pixel 210.

A viewer recognizes an image output to the area thinly populated with the projected light beams to be an image darker than an image output to the area densely populated with the projected light beams from among the areas on the screen 120.

A luminance distribution of an overall image displayed on the screen 120 may not be uniform because luminances of the images output to the areas on the screen 120 differ from one another.

Since the technical features described with reference to FIGS. 1 through 3 may he directly applicable here, a detailed description will be omitted.

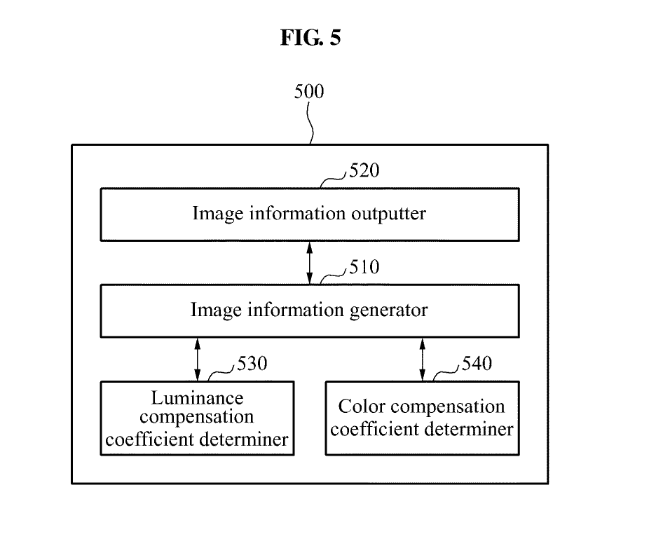

FIG. 5 illustrates an apparatus 500 for image processing according to an example embodiment.

Referring to FIG. 5, the apparatus 500 for image processing includes an image information generator 510, an image information outputter 520, a luminance compensation coefficient determiner 530, and a color compensation coefficient determiner 540.

The image information generator 510, image information outputter 520, luminance compensation coefficient determiner 530, and color compensation coefficient determiner 540 may he hardware, firmware, hardware executing software or any combination thereof. When at least one of the image information generator 510, image information outputter 520, luminance compensation coefficient determiner 530, and color compensation coefficient determiner 540 is hardware, such existing hardware may include one or more Central Processing Units (CPUs), digital signal processors (DSPs), application-specific-integrated-circuits (ASICs), field programmable gate arrays (FPGAs) computers or the like configured as special purpose machines to perform the functions of the at least one of the image information generator 510, image information outputter 520, luminance compensation coefficient determiner 530, and color compensation coefficient determiner 540 is hardware. CPUs, DSPs, ASICs and FPGAs may generally be referred to as processors and/or microprocessors.

In the event where at least one of the image information generator 510, image information outputter 520, luminance compensation coefficient determiner 530, and color compensation coefficient determiner 540 is hardware is a processor executing software, the processor is configured as a special purpose machine to execute the software to perform the functions of the at least one of the image information generator 510, image information outputter 520, luminance compensation coefficient determiner 530, and/or color compensation coefficient determiner 540 is hardware. In such an embodiment, the processor may include one or more Central Processing Units (CPUs), digital signal processors (DSPs), application-specific-integrated-circuits (ASICs), field programmable gate arrays (FPGAs) computers.

The apparatus 500 for image processing generates information about at least one image based on information included in at least one light beam projected by the at least one light source 110, outputs the generated information about the at least one image to control the at least one light source 110.

The apparatus 500 for image processing controls luminance and color information of the at least one light beam projected from the at least one light source 110 by controlling the at least one light source 110.

Luminance and color information of an overall image output to the screen 120 may be uniform when the at least one light beam of which the luminance and/or color information controlled by the apparatus 500 for image processing is emitted from the at least one light source 110, and the emitted light beam passes through the screen 120.

The apparatus 500 for image processing is provided separately from the at least one light source 110 and the screen 120. The apparatus 500 for image processing, the at least one light source 110, and the screen 120 configure a portion of a flat display device or a multi-view 3D display device. For example, the at least one light source 110 may be projectors. The apparatus 500 for image processing outputs information associated with images to each of the at least one light source 110. As used herein, the information associated with the images may refer to information used by a light source to output an image. The information associated with the images may refer to data of an image.

The luminance compensation coefficient determiner 530 determines a luminance compensation coefficient to compensate for a luminance of at least one light beam emitted from the at least one light source 110. The luminance compensation coefficient determiner 530 processes an operation to determine the luminance compensation coefficient. The luminance compensation coefficient is determined for each of the at least one light beam emitted from the at least one light source 110 or for each of the at least one light source 110.

The color compensation coefficient determiner 540 determines a color compensation coefficient to compensate for color information of the at least one light beam emitted from the at least one light source 110. The color compensation coefficient determiner 540 processes an operation to determine the color compensation coefficient. The color compensation coefficient is determined for each of the at least one light beam emitted from the at least one light source 110 or for each of the at least one light source 110.

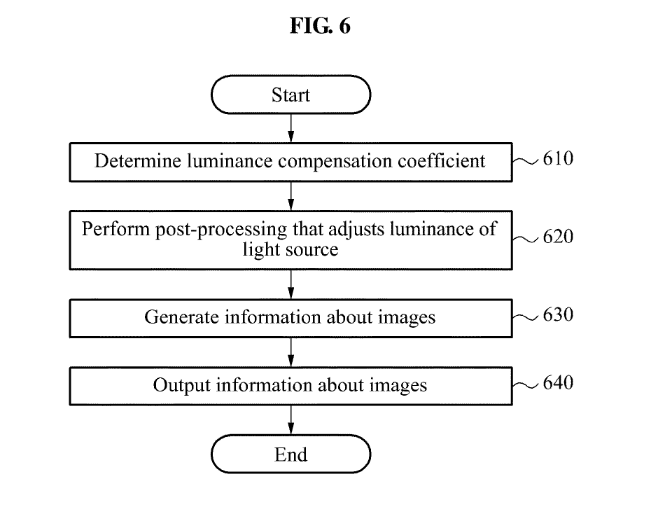

A method of determining a luminance compensation coefficient and a color compensation coefficient will be described with reference to FIGS. 6 through 14.

The image information generator 510 generates information associated with images output to the screen 120 based on the luminance compensation coefficient and/or color compensation coefficient determined by the luminance compensation coefficient determiner 530 and/or color compensation coefficient determiner 540. The at least one light source 110 is controlled by the generated information associated with the images.

The image information outputter 520 outputs the information associated with the images generated by the image information generator 510 to the at least one light source 110. The image information outputter 520 may refer to a hardware module that outputs information to the at least one light source 110. For example, the image information outputter 520 includes a port to output information to the at least one light source 110. Each of the at least one light source 110 is connected to the apparatus 500 for image processing through the port.

Descriptions pertaining to functions and operations of the image information generator 510 and the image information outputter 520 will be provided with reference to FIG. 6.

Since the technical features described with reference to FIGS. 1 through 4 may be directly applicable here, a detailed description will be omitted for conciseness.

FIG. 6 illustrates a method of image processing according to example embodiments.

As previously described with reference to FIG. 5, the apparatus 500 for image processing controls a luminance of at least one light beam projected to the surface of the screen 120 by controlling the at least one light source 110. A luminance distribution of an overall image output to the screen 120 may be made uniform by the apparatus 500 for image processing controlling the luminance of the at least one light beam projected to the surface of the screen 120.

A method in which a luminance compensation coefficient is determined and the luminance of the at least one light beam projected to the surface of the screen 120 through the at least one light source 110 is controlled is illustrated in FIG. 6.

At operation 610, the luminance compensation coefficient determiner 530 determines a luminance compensation coefficient of at least one light beam based on a spatial angular distribution of the at least one light beam projected from the at least one light source 110. The luminance compensation coefficient is used to control the at least one light source 110 to control the luminance of the at least one light beam projected to the surface of the screen 120. The luminance of the at least one light source 110 is controlled by the determined luminance compensation coefficient.

The luminance compensation coefficient determined by the luminance compensation coefficient determiner 530 is determined for each of the at least one light source 110.

Alternatively, the luminance compensation coefficient determined by the luminance compensation coefficient determiner 530 is determined for each of at least one light beam projected from the at least one light source 110. For example, the luminance compensation coefficient is determined for a plurality of light beams projected from the at least one light source 110 that passes through a pixel in an image output to the screen 120. Alternatively, the luminance compensation coefficient is determined for each light beam among all beams that pass through the screen 120 via the pixel.

The luminance compensation coefficient is determined for each pixel in the image output to the screen 120 that the plurality of light beams projected from the at least one light source 110 passes through. For example, the luminance compensation coefficient is determined for the plurality of light beams projected from the at least one light source 110 that passes through the pixel, for each pixel in the image through which the plurality of light beams projected from the at least one light source 110 passes.

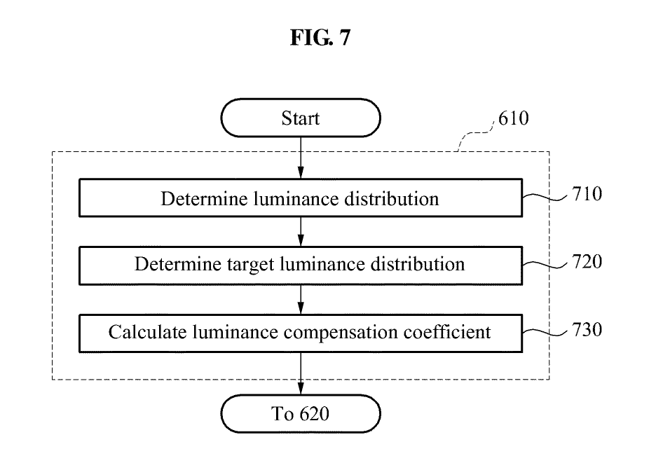

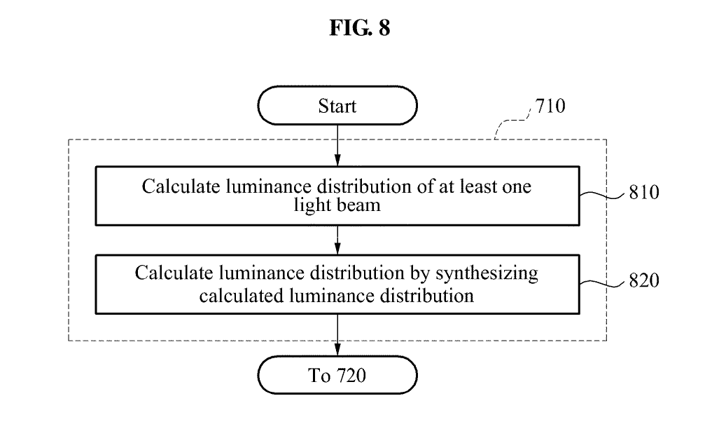

A method of determining the luminance compensation coefficient will be described with reference to FIGS. 7 and 8.

At operation 620, the luminance compensation coefficient determiner 530 performs post-processing in which the luminance of the at least one light source 110 is adjusted. The post-processing performed to adjust the luminance of the at least one light source 110 is performed by adjusting the luminance compensation coefficient determined at operation 610. The luminance compensation coefficient determiner 530 adjusts the luminance of the at least one light source 110 by adjusting the luminance compensation coefficient determined at operation 610. A luminance of images output to the screen 120 is adjusted by adjusting the luminance of the at least one light source 110.

For example, the luminance compensation coefficient determiner 530 may increase or decrease the luminance of the at least one light source 110 by a predetermined and/or desired rate. The predetermined and/or desired rate is determined based on a luminance distribution to be determined at operation 710 and a target luminance distribution to be determined at operation 720 with reference to FIG. 7.

The luminance compensation coefficient determiner 530 adjusts the luminance of the at least one light source 110 that emits the at least one light beam that passes through the pixel in the image output to the screen 120.

Operation 620 may be performed selectively. For example, when a luminance distribution of an overall image satisfies a predetermined and/or desired condition, operation 620 may not be performed. As used herein, the overall image may refer to an image output to the screen 120 through which the at least one light beam projected by the at least one light source 110 passes. The at least one light beam is output at the luminance adjusted by the luminance compensation coefficient determined at operation 610.

Alternatively, operation 620 may be performed when a range of luminance compensation coefficient values determined at operation 610 exceeds a predetermined and/or desired range available to be used in the apparatus 500 for image processing and/or the at least one light source 110.

At operation 620, the luminance compensation coefficient determiner 530 identifies the luminance compensation coefficients that exceed the predetermined and/or desired range available to be used in the apparatus 500 for image processing and/or the at least one light source 110, and changes the identified luminance compensation coefficients to values within the predetermined and/or desired range available to be used in the apparatus 500 for image processing and the at least one light source 110.

Alternatively, at operation 620, the luminance compensation coefficient determiner 530 compensates for the luminance compensation coefficients to allow a distribution of the luminance compensation coefficients to be uniform based on the distribution of the luminance compensation coefficients. For example, the luminance compensation coefficient determiner 530 identifies luminance compensation coefficients protruded on the distribution of the luminance compensation coefficients, and changes each of the identified luminance compensation coefficients to an average value of luminance compensation coefficients in a vicinity of each of the identified luminance compensation coefficients.

Alternatively, at operation 620, the luminance compensation coefficient determiner 530 normalizes the luminance compensation coefficients to a value greater than zero and less than “1” based on the distribution of the luminance compensation coefficients, based on a maximum value from among the luminance compensation coefficients.

Alternatively, at operation 620, the luminance compensation coefficient determiner 530 adjusts the luminance compensation coefficients by multiplying a predetermined and/or desired value and the luminance compensation coefficients. The luminance of the images output to the screen 120 is adjusted in response to the predetermined and/or desired value being multiplied with the luminance compensation coefficients.

At operation 630, the image information generator 510 generates information about at least one image based on the determined luminance compensation coefficient. The information about the at least one image generated by the image information generator 510 may refer to information associated with the at least one image to be output to the screen 120 by the at least one light beam projected to the surface of the screen 120 from the at least one light source 110. The generated information about the at least one image includes information associated with a luminance of each of the at least one light source 110 and/or information associated with a luminance of each of the at least one light beam projected by each of the at least one light source 110.

At operation 640, the image information outputter 640 outputs the generated information about the at least one image to the at least one light source 110.

The luminance of the at least one light source 110 is controlled by the generated information about the at least one image being output to the at least one light source 110. For example, the information about the at least one image is output to the at least one light source 110 to which the at least one light beam configuring each of the at least one image is projected.

A luminance for each of the at least one light source 110 is controlled by the information about the at least one image being output to the at least one light source 110. For example, the luminance of the at least one light source 110 is controlled for each light source based on the luminance compensation coefficient value determined by the luminance compensation coefficient determiner 530. Each light source emits at least one light beam having a luminance controlled for the each light source.

Since the technical features described with reference to FIGS. 1 through 5 may be directly applicable here, a detailed description will be omitted for conciseness.

FIG. 7 illustrates a method of determining a luminance compensation coefficient according to an example.

Operation 610 previously described with reference to FIG. 6 includes operations 710 through 730.

At operation 710, the luminance compensation coefficient determiner 530 determines a luminance distribution of at least one light beam based on a spatial angular distribution of the at least one light beam. For example, the luminance compensation coefficient determiner 530 determines a luminance distribution of at least one light beam projected from the at least one light source 110 that passes through a pixel in an image output to the screen 120.

Φ(θ) denotes a luminance distribution with respect to a spatial angle θ of a light beam that passes through a pixel in an image output to the screen 120. Φ(θ) corresponds to the aforementioned function f(θ) described with reference to FIG. 3. For example, Φ(θ) indicates a Gaussian distribution. When a number of light beams that pass through a pixel is “K”, a luminance distribution Φ of light beams that pass through a pixel is represented by Equation 4.

Φ=[₁, Φ₂, . . . , Φ_{K}] [Equation 4]

In Equation 4, “K” denotes an integer greater than “1”. Φ may be provided in a form of a matrix. Each row of Φ includes a luminance distribution of each light beam. Φ may be a matrix including the luminance distribution of each light beam as each row.

The luminance distribution Φ is determined based on a simulation or a trial with respect to at least one light beam emitted from at least one light source.

For example, the luminance distribution Φ is determined based on an optical simulation that uses at least one of information associated with a disposition of the at least one light source 110, information associated with a position of the screen 120, and information associated with a position of pixels in an image. The luminance distribution Φ is obtained based on at least one item of the following information regarding a spatial angle for each light beam obtained through an optical simulation, a luminance value, and viewer recognition with respect to a light beam.

A method of calculating at least one light beam will be described with reference to FIGS. 8, 11 and 12.

At operation 720, the luminance compensation coefficient determiner 530 determines a target luminance distribution based on the luminance distribution determined at operation 710.

The target luminance distribution may refer to a distribution indicating a uniform luminance value within a predetermined and/or desired range of a viewing angle. The predetermined and/or desired range of the viewing angle may be included in a range in which the luminance distribution Φ exists. The predetermined and/or desired range of the viewing angle is determined by the luminance compensation coefficient determiner 530 based on the luminance distribution Φ determined at operation 710. The predetermined and/or desired range of the viewing angle is determined for a plurality of pixels in an image output to the screen 120.

The target luminance distribution having a uniform luminance value within the predetermined and/or desired range of the viewing angle is represented by “t”.

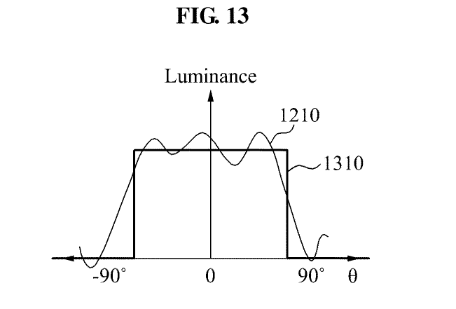

A method of determining the target luminance distribution will be described with reference to FIG. 13.

At operation 730, the luminance compensation coefficient determiner 530 calculates a luminance compensation coefficient of at least one light beam based on the determined luminance distribution Φ and the determined target luminance distribution “t”. As previously described with reference to FIG. 6, the luminance compensation coefficient is determined for each of the at least one light beam projected from the at least one light source 110 that passes through a pixel in an image output to the screen 120. For example, a luminance compensation coefficient with respect to a light beam i, greater than “1” and less than K. that passes through a pixel with respect to an integer i is represented by wᵢ. The luminance distribution of the light beam i controlled by the luminance compensation coefficient wᵢ is represented by Equation 5.

Φ′ᵢ=wᵢΦᵢ [Equation 5]

Luminance compensation coefficients with respect to K number of light beams that pass through a pixel are expressed by Equation 6. The compensation coefficient wᵢ is a value greater than zero and less than “1”.

w=[w₁, w₂, . . . , w_{K}]^{T} [Equation 6]

The luminance compensation coefficient determiner 530 determines the luminance compensation coefficient based on a similarity between the luminance distribution Φ and the determined target luminance distribution t. For example, the luminance compensation coefficient determiner 530 calculates, to be luminance compensation coefficients, values that allow the luminance distribution Φ to approach closest to the target luminance distribution.

The luminance compensation coefficient determiner 530 determines solutions of Equation 7 to be luminance compensation coefficients.

Φw=t [Equation 7]

The luminance compensation coefficient determiner 530 uses, for example, a regression analysis method or a method of least squares, to calculate luminance compensation coefficients.

Alternatively, the luminance compensation coefficient determiner 530 uses conventional methods widely known in a data fitting field to calculate the luminance compensation coefficients.

Alternatively, the luminance compensation coefficient determiner 530 uses a pseudo inverse matrix to calculate the luminance compensation coefficients.

Alternatively, the luminance compensation coefficient determiner 530 calculates the luminance compensation coefficients by adding a predetermined and/or desired condition to the solutions of Equation 7. For example, the luminance compensation coefficient determiner 530 uses a non-negative least squares optimization method, a feasible generalized least squares (FGLS) method, a Tikhonov regularization method, a least absolute shrinkage and selection operator (LASSO) method, or a linear programming minimization method to calculate the luminance compensation coefficients.

The luminance compensation coefficient determiner 530 calculates the luminance compensation coefficients for each pixels among all pixels in the image output to the screen 120.

Since the technical features described with reference to FIGS. 1 through 6 may be directly applicable here, a detailed description will be omitted for conciseness.

FIG. 8 illustrates a method of calculating a luminance distribution of at least one light beam according to an example.

Operation 710 previously described with reference to FIG. 6 includes operations 810 and 820.

At operation 810, the luminance compensation coefficient determiner 530 calculates a luminance distribution of at least one light beam based on a spatial angular distribution of the at least one light beam projected by the at least one light source 110. The luminance distribution of the at least one light beam differs based on a spatial angle at which the at least one light beam passes through the screen 120. For example, the luminance distribution of the at least one light beam represents a Gaussian distribution in which a position of a peak differs based on the spatial angle at which the at least one light beam passes through the screen 120. The luminance distribution of the at least one light beam corresponds to the aforementioned luminance distribution Φ(θ) previously described with reference to FIG. 7.

At operation 820, the luminance compensation coefficient determiner 530 calculates the luminance distribution of the at least one light beam by synthesizing the luminance distribution calculated at operation 810. For example, the luminance compensation coefficient determiner 530 calculates the luminance distribution of the at least one light beam by synthesizing the luminance distribution of the at least one light beam calculated at operation 810 with luminance distributions of other light beams.

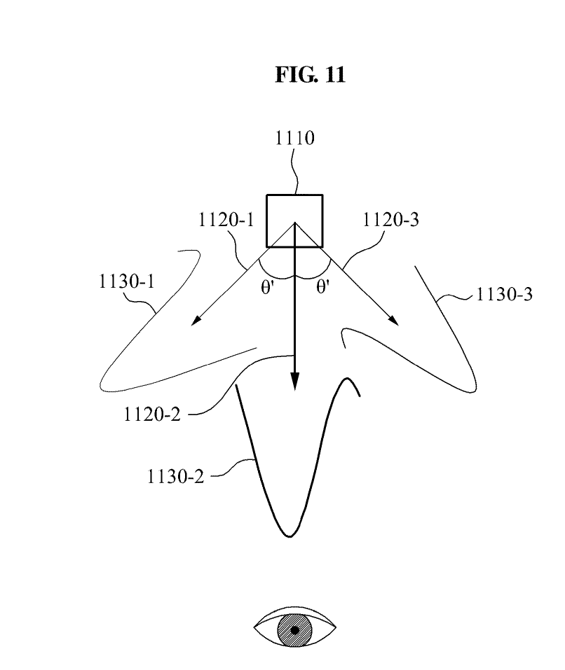

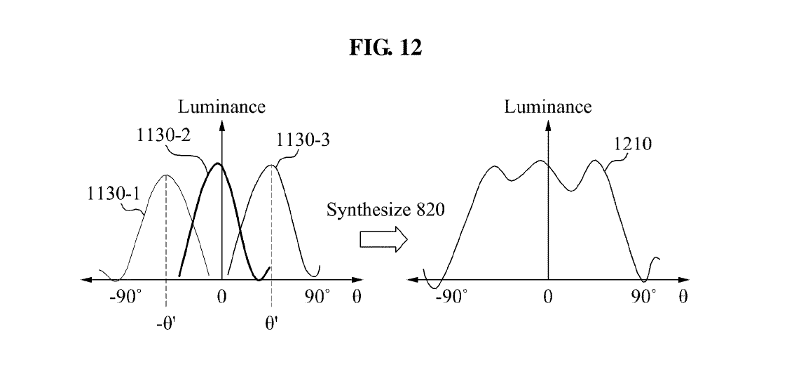

A method of calculating the luminance distribution of the at least one light beam will be described with reference to FIGS. 11 and 12.

Since the technical features described with reference to FIGS. 1 through 7 may be directly applicable here, a detailed description will be omitted for conciseness.

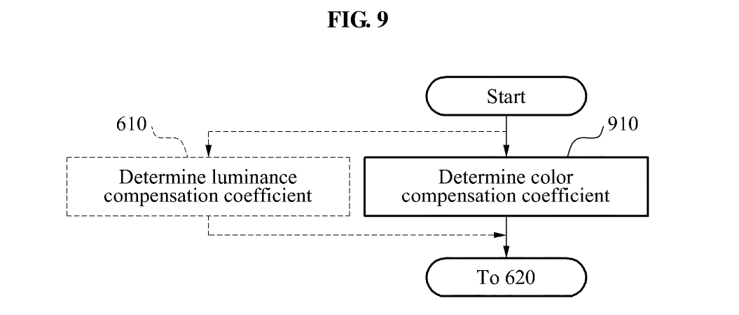

FIG. 9 illustrates a method of image processing according to an example.

As previously described with reference to FIGS. 1 through 5, when at least one light beam is projected to the surface of the screen 120 at differing spatial angles, color information of the projected light beam differs based on a spatial angle at which each of the at least one light beam is projected. Color information of the overall image output to the screen 120 may not be uniform because the color information of the projected light beam may change, based on a spatial angle θ at which a light beam is projected. The apparatus 500 for image processing controls the color information of the at least one light beam projected by the at least one light source 110 by controlling the at least one light source 110. The color information of the overall image output to the screen 120 may be even when a light beam of which the color information controlled by the apparatus 500 for image processing is emitted from the at least one light source 110, and the emitted light beam passes through the screen 120. The color information controlled by the apparatus 500 for image processing corresponds to at least one of a red (R) value, a green (G) value, a blue (B) value, and a gamma value included by the at least one light beam.

A method in which a color compensation coefficient is determined, and the color information of the at least one light beam projected to the surface of the screen 120 through the at least one light source 110 is controlled by the determined color compensation coefficient is illustrated in FIG. 9.

At operation 910, the color compensation coefficient determiner 540 determines a color compensation coefficient of at least one light beam based on a spatial angular distribution of the at least one light beam projected from the at least one light source 110.

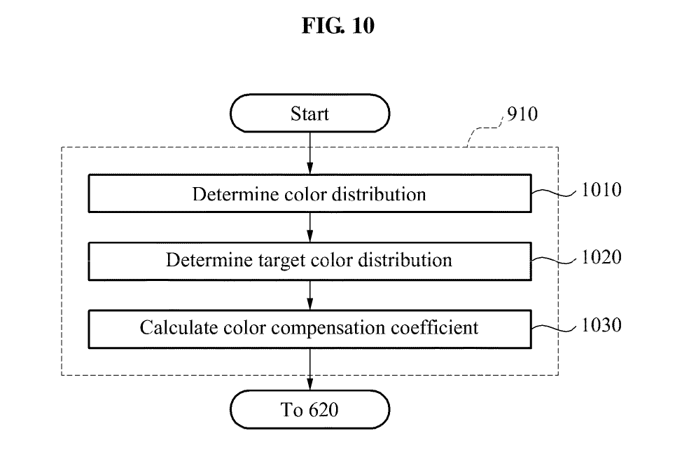

A method of determining the color compensation coefficient will be described with reference to FIG. 10.

At operation 630, the image information generator 510 generates information about at least one image based on at least one of the determined luminance compensation coefficient and the determined color compensation coefficient.

Operations 610 and 910 may be performed selectively. Alternatively, operations 610 and 910 may be performed simultaneously or sequentially.

Descriptions of the luminance compensation coefficient determiner 530, the luminance, and the luminance compensation coefficient described with reference to FIGS. 1 through 8 may be applied to the color compensation coefficient determiner 540, the color information, and the color compensation coefficient and thus, repeated descriptions will be omitted here for conciseness.

FIG. 10 illustrates a method of determining a color compensation coefficient according to an example.

Operation 910 previously described with reference to FIG. 9 includes operations 1010 through 1030.

At operation 1010, the color compensation coefficient determiner 540 determines a color distribution of at least one light beam based on a spatial angular distribution of the at least one light beam. The color distribution determined at operation 1010 corresponds to at least one of distributions of R, G, B, and gamma of the at least one light beam.

At operation 1020, the color compensation coefficient determiner 540 determines a target color distribution based on the color distribution determined at operation 1010. The target color distribution is determined based on content processed based on the method of image processing performed by the apparatus 500 for image processing. The target color distribution is determined differently based on a characteristic or type of the content.

At least one image output to the screen 120 may refer to an image displaying content. The at least one image output to the screen 1.20 may refer to an image generated by the apparatus 500 for image processing playing the content. Alternatively, the content may refer to information associated with at least one picture included by the at least one image output to the screen 12.0.

The color compensation coefficient determiner 540 determines the color distribution and/or the target color distribution of the at least one light beam when the content processed by the apparatus 500 for image processing changes.

At operation 1030, the color compensation coefficient determiner 540 calculates a color compensation coefficient of the at least one light beam based on the determined color distribution and the determined target color distribution.

Descriptions of the luminance compensation coefficient determiner 530, the luminance, the luminance distribution, the target luminance distribution, and the luminance compensation coefficient described with reference to FIGS. 1 through 8 may be applied to the color compensation coefficient determiner 540, the color information, the color distribution, the target color distribution, and the color compensation coefficient and thus, repeated descriptions will be omitted here for conciseness.

FIG. 11 illustrates at least one light beam that passes through a pixel 1110 according to an example.

As previously described with reference to FIG. 2, at least one light beam projected from the at least one light source 110 converges on the pixel 210 in the image output to the screen 120. The at least one light beam converging on the pixel 210 is projected to the surface of the screen 120 at differing spatial angles, and emitted to the screen 120.

The pixel 1110 corresponds to the pixel 210 previously described with reference to FIG. 2, and light beams 1120-1 through 1120-3 projected through the pixel 1110 correspond to each of the light beams 220-1 through 220-3 projected through the pixel 210.

The light beam 1120-1 is projected to a spatial angle of −θ′, and the light beam 1120-3 is projected to a spatial angle of θ′.

Each of luminance distributions 1130-1 through 1130-3 corresponds to a luminance distribution of each of the light beams 1120-1 through 1120-3. Each of the luminance distributions 1130-1 through 1130-3 corresponds to Φ(θ) previously described with reference to FIG. 7. Each of the luminance distributions 1130-1 through 1130-3 indicates a Gaussian distribution.

Alternatively, each of the luminance distributions 1130-1 through 1130-3 corresponds to a color distribution of each of the light beams 1120-1 through 1120-3. Each of the color distributions 1130-1 through 1130-3 indicates a Gaussian distribution.

A luminance distribution or a color distribution of the light beams 1120-1 through 1120-3 is determined based on the distributions 1130-1 through 1130-3.

The pixel 1110 may correspond to a sub-pixel. In the following description of example embodiments, unless otherwise indicated, the term “pixel” may refer to the sub-pixel.

Since the technical features described with reference to FIGS. 1 through 10 may be directly applicable here, a detailed description will be omitted for conciseness.

Descriptions of the luminance compensation coefficient determiner 530, the luminance, the luminance distribution, the target luminance distribution, and the luminance compensation coefficient described with reference to FIGS. 12 through 17 may be applied to the color compensation coefficient determiner 540, the color information, the color distribution, the target color distribution, and the color compensation coefficient and thus, repeated descriptions will be omitted here for conciseness.

FIG. 12 illustrates a method of calculating a luminance distribution of at least one light beam according to an example.

The luminance distributions 1130-1 through 1130-3 of each of the light beams 1120-1 through 1120-3 and a luminance distribution 1210 of the light beams 1120-1 through 1120-3 previously described with reference to FIG. 11 are illustrated in FIG. 12. Each of the luminance distributions 1130-1 through 1130-3 indicates a Gaussian distribution.

The luminance compensation coefficient determiner 530 calculates the luminance distribution 1210 by synthesizing the luminance distributions 1130-1 through 1130-3. The calculated luminance distribution 1210 corresponds to the luminance distribution Φ described with reference to FIG. 7.

The luminance compensation coefficient determiner 530 determines a target luminance distribution based on the calculated luminance distribution 1210. A method of determining the target luminance distribution will be provided with reference to FIG. 13.

Since the technical features described with reference to FIGS. 1 through 11 may be directly applicable here, a detailed description will be omitted for conciseness.

FIG. 13 illustrates a method of determining a target luminance distribution 1310 according to an example.

The luminance distribution 1210 previously described with reference to FIG. 12 and the target luminance distribution 1310 calculated based on the luminance distribution 1210 are illustrated in FIG. 13.

As previously described with reference to FIG. 7, the target luminance distribution 1310 may refer to a distribution indicating a uniform luminance value within a predetermined and/or desired range of a viewing angle and may correspond to the target luminance distribution t. The predetermined and/or desired range of the viewing angle is determined based on a form of the luminance distribution 1210.

When the luminance distribution 1210 matches the target luminance distribution 1310 by a compensation for the luminances of the light beams 1120-1 through 1120-3, the luminances of the light beams 1120-1 through 1120-3 projected through the pixel 1110 may be made uniform.

The luminance compensation coefficient determiner 530 calculates luminance compensation coefficients of the light beams 1120-1 through 1120-3 based on the luminance distribution 1210 and the target luminance distribution 1310.

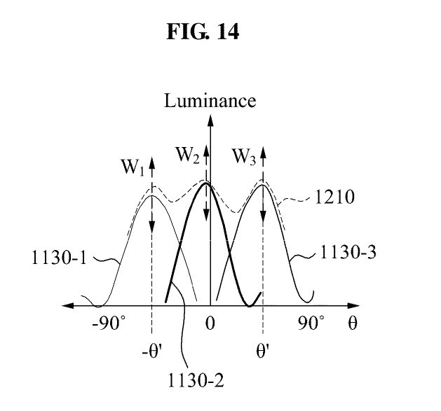

A method of compensating for the luminance of the light beams 1120-1 through 1120-3 using the luminance compensation coefficients will be discussed with reference to FIG. 14.

Since the technical features described with reference to FIGS. 1 through 12 may be directly applicable here, a detailed description will be omitted for conciseness.

FIG. 14 illustrates a method of compensating a luminance using a luminance compensation coefficient according to an example.

Luminance compensation coefficients w₁, w₂, and, w₃ compensate for a luminance of each of the light beams 1120-1 through 1120-3. The luminance compensation coefficients w₁, w₂ and, w₃ compensate for luminances of light sources emitting the light beams 1120-1 through 1120-3.

The luminance distribution 1210 may approach close to the target luminance distribution 1310 by peaks of the luminance distribution 1130-1 through 1130-3 being controlled by the luminance compensation coefficients w₁, w₂, and, w₃. For example, when the luminance compensation coefficients w₁, w₂, and, w₃ are greater than zero and less than “1”, peak values of the luminance distributions 1130-1 through 1130-3 decrease, and the luminance distribution 1210 approaches close to the target luminance distribution 1310. When the luminance compensation coefficients w₁, w₂, and, w₃ are greater than zero and less than “1”, a luminance of images output to the screen 120 decreases in response to the light beams 1120-1 through 1120-3 being projected to the surface of the screen 120 because luminances subsequent to a compensation are less than luminances prior to the compensation. The luminance compensation coefficient determiner 530 re-adjusts the luminance compensation coefficients w₁, w₂, and, w₃ by performing the post-processing of operation 620, and increases the luminance of the images output to the screen 120 through the re-adjusting.

Since the technical features described with reference to FIGS. 1 through 13 may be directly applicable here, a detailed description will be omitted for conciseness.

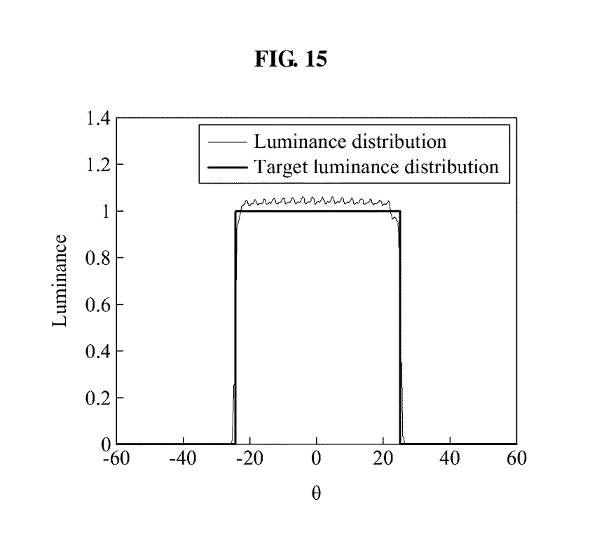

FIG. 15 illustrates a luminance distribution and a target luminance distribution according to an example.

A luminance distribution of the at least one light beam and a target luminance distribution determined based on the luminance distribution of the at least one light beam are illustrated in FIG. 15. As shown in FIG. 15, a luminance distribution prior to a luminance compensation is not uniform to a greater extent than the target luminance distribution.

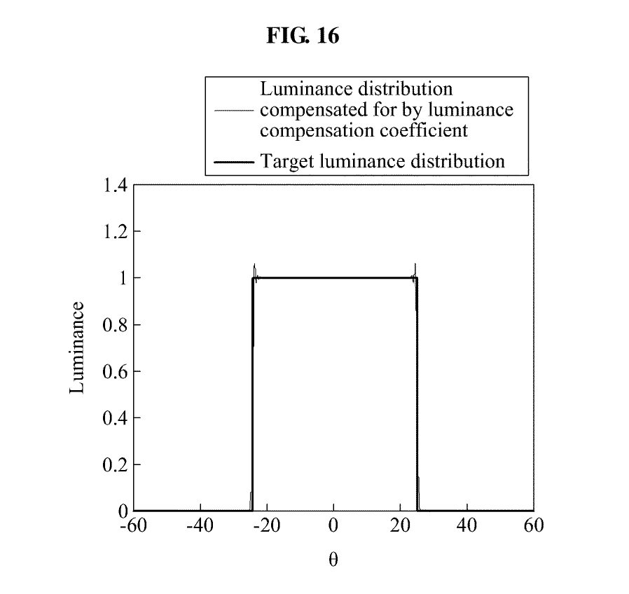

FIG. 16 illustrates a luminance distribution compensated by a luminance compensation coefficient and a target luminance distribution according to an example.

A luminance of the at least one light source 110 is compensated by luminance compensation coefficients determined by the luminance compensation coefficient determiner 530.

As illustrated in FIG. 16, a luminance distribution of at least one light beam projected from the at least one light source 110 approaches close to a target luminance distribution.

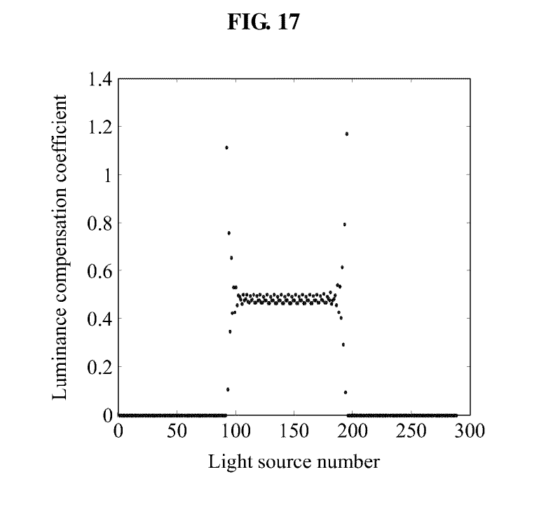

FIG. 17 illustrates a luminance compensation coefficient according to an example.

As previously described with reference to FIG. 7, the luminance compensation coefficient is determined for a plurality of light beams projected from the at least one light source 110 that passes through a pixel in an image output to the screen 120. A number of the luminance compensation coefficients shown in FIG. 17 may correspond to a number of the plurality of light beams that passes through the pixel, and a number of the at least one light source 110.

The number of light sources of the at least one light source 110 is illustrated to be 96 in FIG. 17. The at least one light source 110, the screen 120, and the apparatus 500 for image processing configure a portion of a 96 views 3D display device.

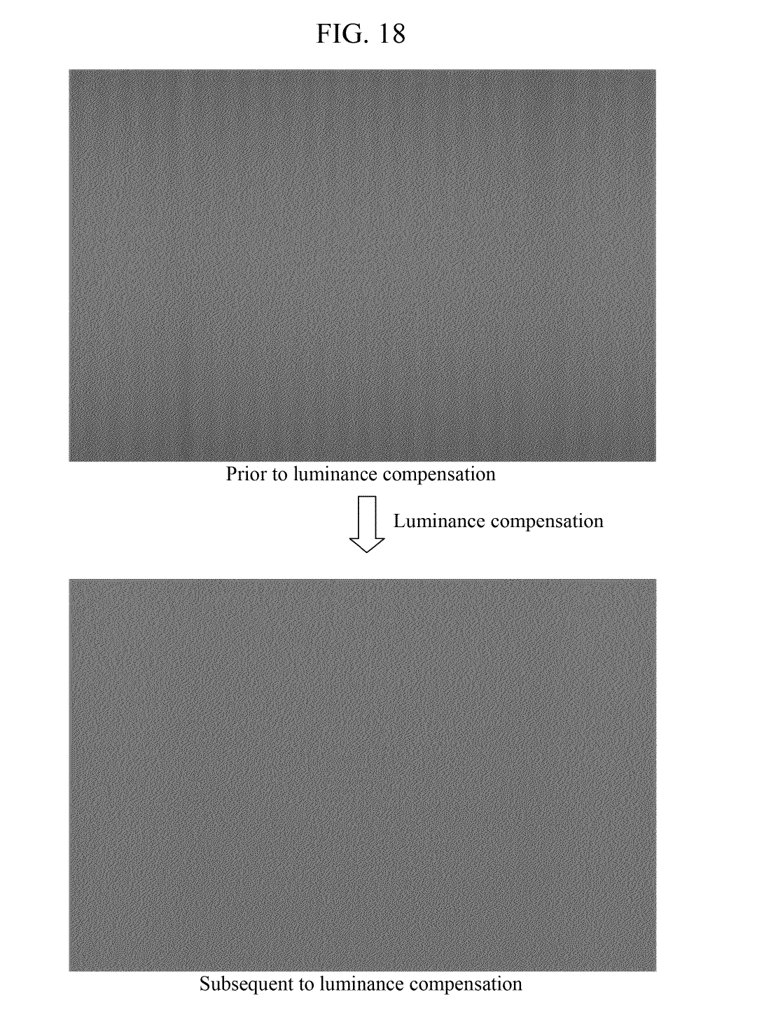

FIG. 18 illustrates a grey image prior to a luminance compensation and a grey image subsequent to a luminance compensation according to an example.

A grey image prior to a luminance compensation performed by the apparatus 500 for image processing and a grey image subsequent to a luminance compensation performed by the apparatus 500 for image processing are illustrated in FIG. 18.

As shown in FIG. 18, a luminance of the grey image prior to the luminance compensation output to the screen 120 is more uniform than a luminance of the grey image subsequent to the luminance compensation.

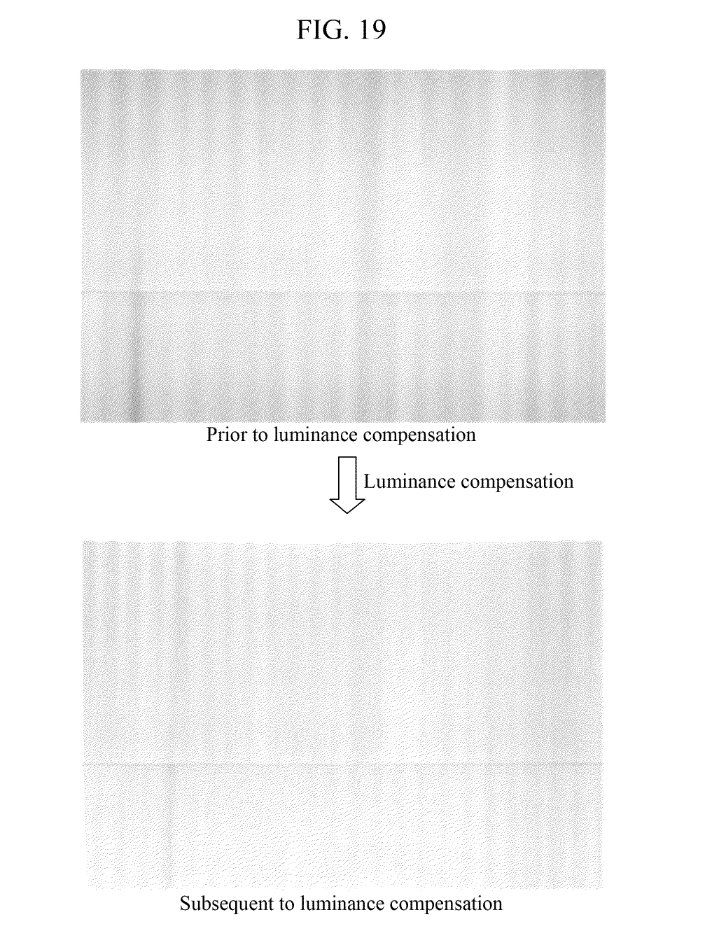

FIG. 19 illustrates a white image prior to a luminance compensation and a white image subsequent to a luminance compensation according to an example.

A white image prior to a luminance compensation performed by the apparatus 500 for image processing and a white image subsequent to a luminance compensation performed by the apparatus 500 for image processing are illustrated in FIG. 19.

As shown in FIG. 19, a luminance of the white image prior to the luminance compensation output to the screen 120 is more uniform than a luminance of the white image subsequent to the luminance compensation.

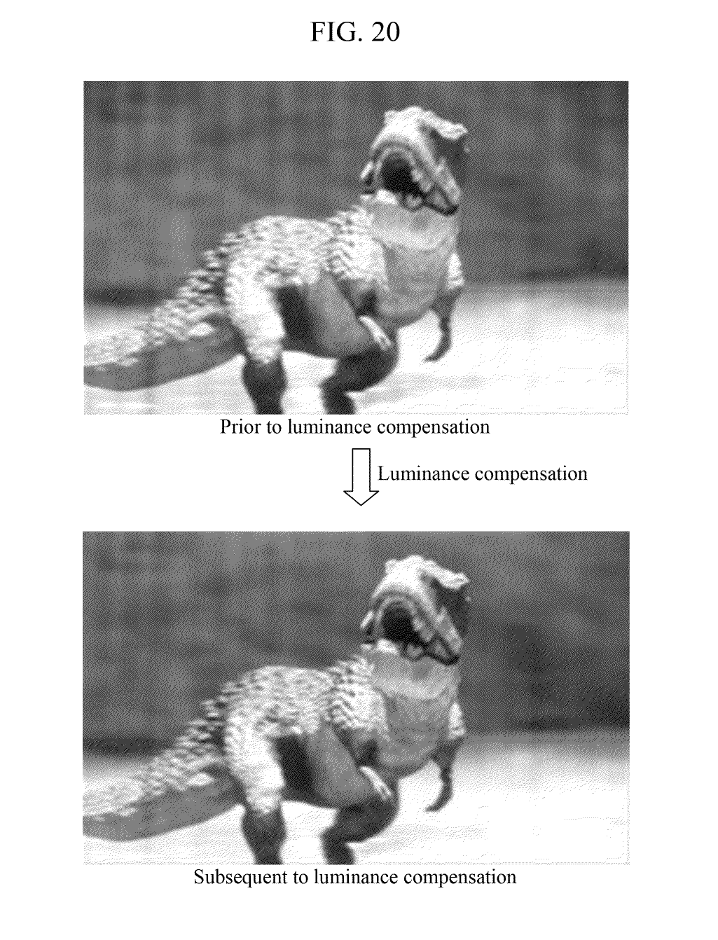

FIG. 20 illustrates a content image prior to a luminance compensation and a content image subsequent to a luminance compensation according to an example.

Content of an image prior to a luminance compensation performed by the apparatus 500 for image processing and content of an image subsequent to a luminance compensation performed by the apparatus 500 for image processing are illustrated in FIG. 20.

As shown in FIG. 20, a luminance of the content of the image prior to the luminance compensation output to the screen 120 is more uniform than a luminance of the content of the image subsequent to the luminance compensation.

The above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. The non-transitory computer-readable media may also be a distributed network, so that the program instructions are stored and executed in a distributed fashion. The program instructions may be executed by one or more processors. The non-transitory computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

Although example embodiments have been shown and described, it would be appreciated by those skilled in the art that changes may be made in these example embodiments without departing from the principles and spirit of the disclosure, the scope of which is defined by the claims and their equivalents.

What is claimed is:

1. A method of image processing, the method comprising:
determining a luminance compensation coefficient of at least one light beam from at least one light source based on a spatial angular distribution of the at least one light beam;
generating information about at least one image based on the determined luminance compensation coefficient; and
outputting the information about the at least one image to the at least one light source.

2. The method of claim 1, wherein the determining of the luminance compensation coefficient comprises:
determining a luminance distribution of the at least one light beam based on the spatial angular distribution;
determining a target luminance distribution based on the determined luminance distribution; and
calculating the determined luminance compensation coefficient of the at least one light beam based on the determined luminance distribution and the determined target luminance distribution.

3. The method of claim 2, wherein the
at least one light beam passes through a pixel in the image.

4. The method of claim 2, wherein the calculating of the determined luminance compensation coefficient comprises:
determining the determined luminance compensation coefficient based on a similarity between the determined luminance distribution and the determined target luminance distribution.

5. The method of claim 2, wherein the determining the luminance distribution determines the luminance distribution based on empirical data.

6. The method of claim 2, wherein the determining of the luminance distribution comprises:
synthesizing the determined luminance distribution.

7. The method of claim 1, further comprising:
adjusting a luminance of the at least one light source.

8. The method of claim 7, wherein the adjusting increases or decreases a luminance of the at least one light source by a desired rate.

9. The method of claim 1, wherein the luminance compensation coefficient is determined for a plurality of light beams projected from the at least one light source that passes through a pixel in the image.

10. The method of claim 1, wherein the luminance compensation coefficient is determined for a plurality of pixels in the image through which the at least one light beam passes.

11. The method of claim 1, further comprising:
determining a color compensation coefficient of the at least one light beam based on the spatial angular distribution of the at least one light beam; and
generating information about the at least one image based on the determined color compensation coefficient.

12. The method of claim 11, wherein the determining of the color compensation coefficient comprises:
determining a color distribution of the at least one light beam based on the spatial angular distribution;
determining a target color distribution based on the determined color distribution; and
calculating the determined color compensation coefficient of the at least one light beam based on the determined color distribution and the determined target color distribution.

13. The method of claim 12, wherein the color distribution corresponds to a distribution of at least one of red (R), green (G), blue (B), and gamma of the at least one light beam.

14. The method of claim 12, wherein the determining the target color distribution determines the target color distribution based on content, and
the at least one image corresponds to an image displaying the content.

15. A non-transitory computer-readable medium comprising a program configured to perform the method of claim 1 if executed on a computer.

16. An apparatus for image processing, the apparatus comprising:
a luminance compensation coefficient determiner configured to determine a luminance compensation coefficient of at least one light beam from at least one light source based on a spatial angular distribution of the at least one light beam;
an image information generator configured to generate information about at least one image based on the determined luminance compensation coefficient; and
an image information outputter configured to output the information about the at least one image to the at least one light source.

17. The apparatus of claim 16, wherein the luminance compensation coefficient determiner is configured to determine a luminance distribution of the at least one light beam based on the spatial angular distribution, determine a target luminance distribution based on the determined luminance distribution, and calculate the determined luminance compensation coefficient of the at least one light beam based on the determined luminance distribution and the determined target luminance distribution.

18. The apparatus of claim 16, further comprising:
a color compensation coefficient determiner configured to determine a color compensation coefficient of the at least one light beam based on the spatial angular distribution of the at least one light beam.
wherein the image information generator is configured to generate information about at least one image based on the determined color compensation coefficient.

19. The apparatus of claim 16, wherein the color compensation coefficient determiner is configured to determine a color distribution of the at least one light beam based on the spatial angular distribution, determine a target color distribution based on the determined color distribution, and calculate the determined color compensation coefficient of the at least one light beam based on the determined color distribution and the determined target color distribution.
